(19) United States
(12) Patent Application Publication
(10) Pub. No.: US 2023/0186424 A1
(43) Pub. Date: Jun. 15, 2023

(54) EXTENDED VIEWPORT USING MOBILE DISPLAY AGGREGATION TO ACCESS EXTRA MEDIA CONTENT

(71) Applicants: Interwise Ltd., Ben-Gurion Airport (IL); AT&T Intellectual Property I, L.P., Atlanta, GA (US)

(72) Inventors: Gil From, Herzliya (IL); Avigayil Bar-Asher, Givat Yearim (IL); Jeremy Toeman, Irvington, NY (US)

(73) Assignees: Interwise Ltd., Ben-Gurion Airport (IL); AT&T Intellectual Property I, L.P., Atlanta, GA (US)

(21) Appl. No.: 17/546,821

(22) Filed: Dec. 9, 2021

(51) Int. Cl. G06T 3/00; G09G 3/20; G06F 3/14; G06F 3/04883

(52) U.S. Cl. CPC G06T 3/0087; G09G 3/20; G06F 3/1446; G06F 3/04883; G09G 2354/00; G09G 2300/026; G09G 2320/06; G09G 2356/00; G06F 2203/04806

(57) ABSTRACT

Aspects of the subject disclosure may include, for example, identifying a media content item having first and second portions adapted for presentation according to first and second viewports that facilitate access to an extended portion of the media content item otherwise inaccessible via the first viewport. First and second display devices are associated together, configuration parameters are determined, and a viewport configuration is identified for the first and second viewports according to the configuration parameters. The first and second portions of the media content items are received by the first and second display devices to facilitate first and second presentations of the first and second portions of the media content item. The first and second presentations, according to the viewport configuration, provide a collective display of the extended portion of the media content item. Other embodiments are disclosed.

### FIELD OF THE DISCLOSURE

The subject disclosure relates to extended viewport using mobile display aggregation to access extra media content.

### BACKGROUND

Increasing numbers of mobile subscribers are consuming images and/or videos using their mobile devices. Such consumption is typically personal in nature, with each mobile subscriber consuming their own, personal content. Attempts to share an experience of watching a video together with other people is generally impractical using mobile devices. Despite increasing mobile bandwidths and attainable video resolutions, the limited screen sizes of these devices can make it difficult to clearly see the details of the image or video in a shared setting.

Immersive video applications allow a viewer to interactively view a selective window or viewport within a panoramic, e.g., 360 or spherical video environment. A transformation may be applied to immersive video content, based on a user's line of sight (LoS) and a field of view (FoV) of the user's device. Namely, that portion of an immersive video frame intersecting a projection of the FoV and the LoS may be presented upon the user's screen. Although individual viewing devices, such as virtual reality (VR) goggles, may permit an individual user to experience the immersive environment, such devices are not well suited to viewing such content in a shared viewing context.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of an extendable viewing system functioning within the communication network of FIG. 1 in accordance with various aspects described herein.

FIG. 2B is a block diagram illustrating an example, non-limiting embodiment of a communication architecture functioning within the communication networks of FIGS. 1 and 2A in accordance with various aspects described herein.

FIG. 2C is a block diagram illustrating an example, non-limiting embodiment of an extendable viewing system functioning within the communication network of FIGS. 1 and 2A in accordance with various aspects described herein.

FIG. 2D is a block diagram illustrating an example, non-limiting embodiment of an extendable viewing system functioning within the communication network of FIGS. 1 and 2A in accordance with various aspects described herein.

FIG. 2E is a block diagram illustrating an example, non-limiting embodiment of an extendable viewing system functioning within the communication network of FIGS. 1 and 2A in accordance with various aspects described herein.

FIG. 2F is a block diagram illustrating an example, non-limiting embodiment of an extendable viewing system functioning within the communication network of FIGS. 1 and 2A in accordance with various aspects described herein.

FIG. 2G depicts an illustrative embodiment of a multi-screen viewing process in accordance with various aspects described herein.

FIG. 2H depicts an illustrative embodiment of another multi-screen viewing process in accordance with various aspects described herein.

FIG. 2I depicts an illustrative embodiment of another multi-screen viewing process in accordance with various aspects described herein.

FIG. 2J depicts an illustrative embodiment of yet another multi-screen viewing process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for identifying media content adapted to provide extended viewing regions, including hidden content that is only accessible via a multi-display presentation, configuring a proximate group of display devices to access the extra or hidden media content, and coordinating delivery and presentation of the media content, including the extended viewing regions, in a cohesive manner across a mosaic arrangement of the proximate group of display devices. Other embodiments are described in the subject disclosure.

One or more aspects of the subject disclosure include a process, which includes identifying, by a processing system including a processor, a video content item that includes a first spatial segment adapted for a first presentation according to a primary viewport and a second spatial segment adapted for a second presentation according to an adjacent viewport. The primary and adjacent viewports facilitate access to an extended segment of the video content item otherwise inaccessible via the primary viewport alone. A primary mobile display device is associated with an adjacent mobile display device to obtain a display device association and configuration parameters of the primary and adjacent mobile display devices are identified. A mosaic configuration of the primary and adjacent viewports is also identified according to the configuration parameters. The first and second spatial segments of the video content item are received, with the first spatial segment provided for the first presentation via a first display of the primary mobile display device and the second spatial segment is provided to the adjacent mobile display device to facilitate the second presentation of the second spatial segment via a second display of the adjacent mobile display device. The first and second presentations provide a collective display of the extended segment of the video content item according to the mosaic configuration.

One or more aspects of the subject disclosure include a device, having a processing system including a processor and a memory. The memory stores executable instructions that, when executed by the processing system, facilitate performance of operations. The operations include identifying a media content item comprising a first spatial segment adapted for a first presentation according to a primary viewport and a second spatial segment adapted for a second presentation according to an adjacent viewport. The primary and adjacent viewports facilitate access to an extended segment of the media content item otherwise inaccessible via the primary viewport. A first display device is associated with a second display device and configuration parameters of the first and second display devices are identified. A mosaic configuration of the primary and adjacent viewports is also identified according to the configuration parameters. The first and second spatial segments of the media content item are received, with the first spatial segment provided for the first presentation via a first display of the first display device and the second spatial segment provided to the second display device to facilitate the second presentation of the second spatial segment via a second display of the second display device. The first and second presentations according to the mosaic configuration provide a collective display of the extended segment of the media content item.

One or more aspects of the subject disclosure include a non-transitory, machine-readable medium, that includes executable instructions. The executable instructions, when executed by a processing system including a processor, facilitate performance of operations. The operations include identifying a media content item including a first portion adapted for a first presentation according to a first viewport and a second portion adapted for a second presentation according to a second viewport, the first and second viewports facilitating access to an extended portion of the media content item otherwise inaccessible via the first viewport. A first display device is associated with a second display device, and configuration parameters are determined for the first and second display devices. A viewport configuration of the first and second viewports is identified according to the configuration parameters. The first and second portions of the media content item are received, with the first portion provided for the first presentation via the first display device and the second portion provided to the second display device to facilitate the second presentation of the second portion via the second display device. The first and second presentations provide a collective display of the extended portion of the media content item according to the viewport configuration.

In at least some embodiments, a primary display device, such as a mobile phone or a tablet, may receive the video content, including any extended viewing portions of the content, via a content delivery network. Media content sources may include, without limitation, a media content server, a media broadcast service, on-demand content, local and/or network stored content, e.g., content previously recorded using a digital video recorder (DVR), live content and/or user generated content. By way of example, the video content may be received by the primary display device according to a file transfer and/or content streaming protocol. The primary display device may then distribute at least a portion of the received video content, e.g., any content portions corresponding to extended viewing regions, to one or more adjacent display devices that participate in a multi-screen, or mosaic, extended-view presentation of the video content.

The primary display device may provide at least a portion of the received video content to the adjacent, participating device(s) via a local channel. In at least some embodiments, the local channel may be established according to a peer-to-peer configuration, e.g., in an ad hoc manner between two or more of the participating display devices. Without restriction, the local channel may include a wired channel, e.g., a cabled connection, such as a wired network connection, established between at least some of the participating devices. Alternatively or in addition, the local channel may include a wireless channel. Wireless channels may utilize one or more wireless network protocols, such as those described in IEEE 802.11 standards for wireless local area networks, e.g., Bluetooth and/or WiFi networking protocols. In at least some embodiments, the local channel may include one or more near field communication (NFC) technologies, such as those protocols standardized in ISO/IEC 14443 and ISO/IEC 18000-3 standards.

At least some portions of the content access and distribution process may be conducted in parallel, e.g., to expedite presentation of the media content according to the mosaic configuration. For example, a primary display device may initiate access to, e.g., downloading of, the video content from a content source via a content delivery network before and/or concurrently with configuration of a group of participating display devices. Accordingly, once the group of devices are suitably configured for a multi-screen, or mosaic, extended-view presentation, the primary display device has stored and/or buffered locally a suitable portion of the received video content at the ready to distribute to the adjacent devices via a local channel, e.g., a local area network.

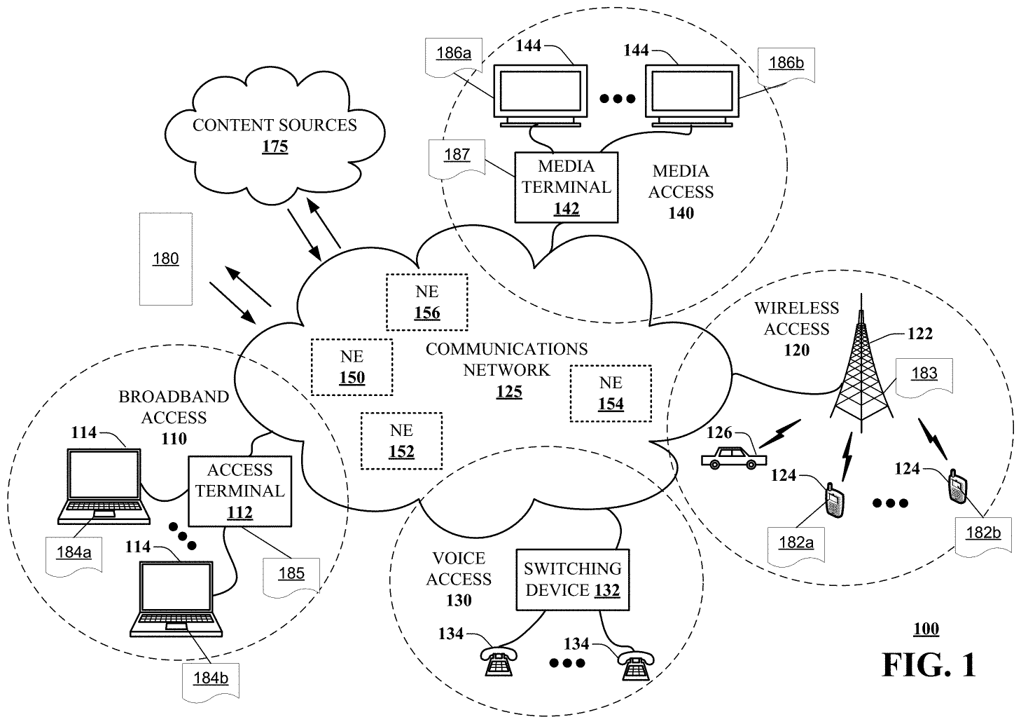

Referring now to FIG. 1, a block diagram is shown illustrating an example, non-limiting embodiment of a system 100 in accordance with various aspects described herein. For example, system 100 can facilitate in whole or in part identifying a media content item adapted for presentation via a multi-screen, or mosaic, extended-view presentation. For example, the extended-view presentation may utilize an extended viewport providing access to at least a portion of video content that is only accessible through an aggregation of multiple display devices. It is envisioned that media content may be prepared and/or otherwise configured to permit access to extra or enhanced portions of extended-view content only when presented to multiple display devices, the extra or enhanced portions otherwise blocked or prevented from viewing by a single display device. In at least some embodiments, the extended-view content includes an extended field of view of an extended video frame, increasing a field-of-view of beyond that of any single display device. For at least those embodiments of a multi-screen mosaic extended-view presentation, it is envisioned that participating display devices include a group of proximate mobile display devices, e.g., arranged in close proximity, preferably abutting each other.

In at least some embodiments, first and second mobile display devices may be associated together, e.g., when the devices are in close proximity to each other, e.g., within some separation threshold, such as less than about 1 inch, or 0.5 inches, or 1 cm. Configuration parameters, such as screen size, resolution, device type, orientation, and so on, may be determined for each of the mobile display devices and/or their proximate group arrangement, or mosaic, to facilitate identification of a corresponding viewport configuration. The first and second portions of the media content items may be obtained by the first and second display devices to facilitate respective presentations of the first and second portions via the proximate group arrangement of the mobile displays. The first and second presentations provide a collective display of the extended portion of the media content item that would be otherwise inaccessible using a lesser number of mobile display devices.

According to the illustrative embodiment of the system 100, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The example system 100 includes a media content source, in this instance, a content delivery server 180, in communication with one or more content sources 175 and one or more other system elements via the example communication network 125. The content sources may be adapted to store media content, including video content, which is adapted for extended-view presentation. Extended view generally indicates that the video content, e.g., video frames, include a wider viewable region than would otherwise be observable by a single display device. Example wide-view video content includes, without limitation, panoramic video, 180 video, 360 video, spherical video, and so on. In at least some instances, the video frame may be referred to as flat, providing extended video frame content beyond that intended for presentation on any single display device, but without necessarily confirming to a spherical format.

In at least some embodiments, the extended video frame content may be prohibited for presentation unless the presentation is configured for multiple display devices. In this manner, a format of the content in cooperation with a distribution and/or presentation policy may promote collaboration between individual viewers. Namely, selective access to at least a portion of the media presentation only to a shared or collaborative environment, may promote social interaction to a small-screen viewing event that might otherwise tend to isolate the viewer. In at least some embodiments, an existence of such hidden content may be advertised to entice such social interactions through multi-screen, or mosaic, extended-view presentations. Such indications and/or advertisements of available hidden or extended video content may be identified by a progress-style bar, e.g., illustrating what content is within view and what is available for extended viewing across multiple screens. Other options for advertising available extended or hidden content may include, without limitation, one or more of a play bar style graphic, a scroll bar, an arrow indicator, a thumbnail view distinguishing viewed and hidden or available unviewed portions of the media content, or the like. In at least some embodiments, such indicators may suggest a preferable configuration, e.g., based on number, type and/or size of participating devices and/or according to a source formatting of the extended view media content.

The content delivery server 180 may provide at least a portion of an extended view media content item to one or more display devices. The display devices may include, without limitation, a data terminal 114 that may include a display, such as a portable computer, a laptop a tablet device, a display device 144, such as a television, e.g., a smart TV, and/or a mobile device 124 that may include a display, e.g., a mobile phone, a tablet, and the like. In at least some embodiments, more than one of the display devices 114, 144, 124 are associated together in a group to permit access to extended portions of the extended view media content. Such a group of devices may include devices of the same kind, e.g., all laptop computers, or all tablet devices, or all mobile phones. Alternatively or in addition, at least some groups of devices may include more than one type of different mobile devices, e.g., a laptop computer 114 and a mobile phone 124, or a smart TV 144 and a tablet device 124.

It is envisioned that the data terminals 114 may include features supporting cooperative extended region viewing 184a, 184b (generally 184), such as multi-display configuration apps, multi-display, e.g., mosaic, presentation apps, proximity sensors, peer-to-peer communication systems, and the like. Alternatively or in addition, an access terminal 112 of the broadband access network 110 may include one or more similar features 185 that may operate alone and/or in cooperation with data terminal features 184.

Likewise, the display terminals 144 may include features supporting cooperative extended region viewing 186a, 186b (generally 186), such as multi-display configuration apps, multi-display, e.g., mosaic, presentation apps, proximity sensors, peer-to-peer communication systems, and the like. Alternatively or in addition, the media terminal 142 of the media access network 110 may include one or more similar features 187 that may operate alone and/or in cooperation with display terminal features 186, the access terminal features 185 and/or the data terminal features 114.

Similarly, the mobile terminals 124 may include features supporting cooperative extended region viewing 182a, 182b (generally 182), such as multi-display configuration apps, multi-display, e.g., mosaic, presentation apps, proximity sensors, peer-to-peer communication systems, and the like. Alternatively or in addition, the access point 122 of the wireless access network 120 may include one or more similar features 183 that may operate alone and/or in cooperation with the mobile terminal features 182, the display terminal features 186, the access terminal features 185 and/or the data terminal features 114.

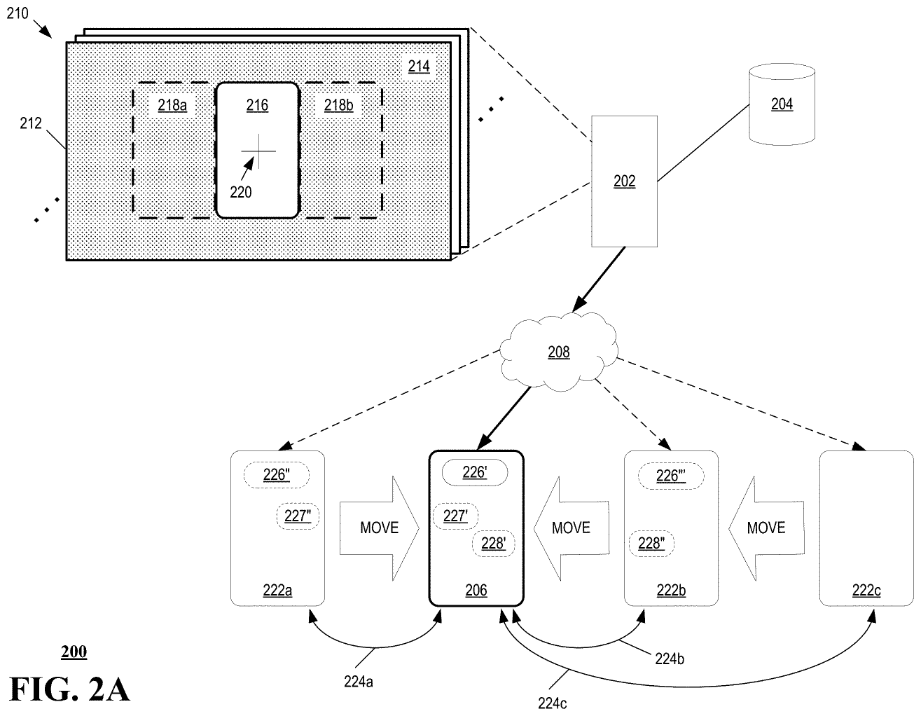

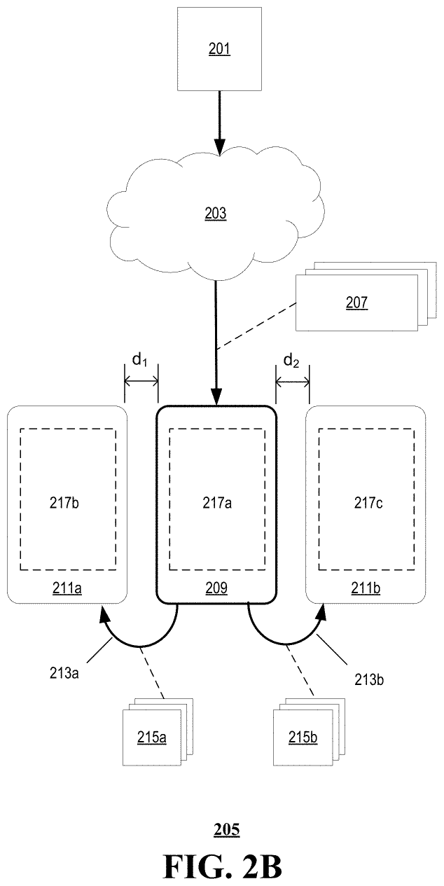

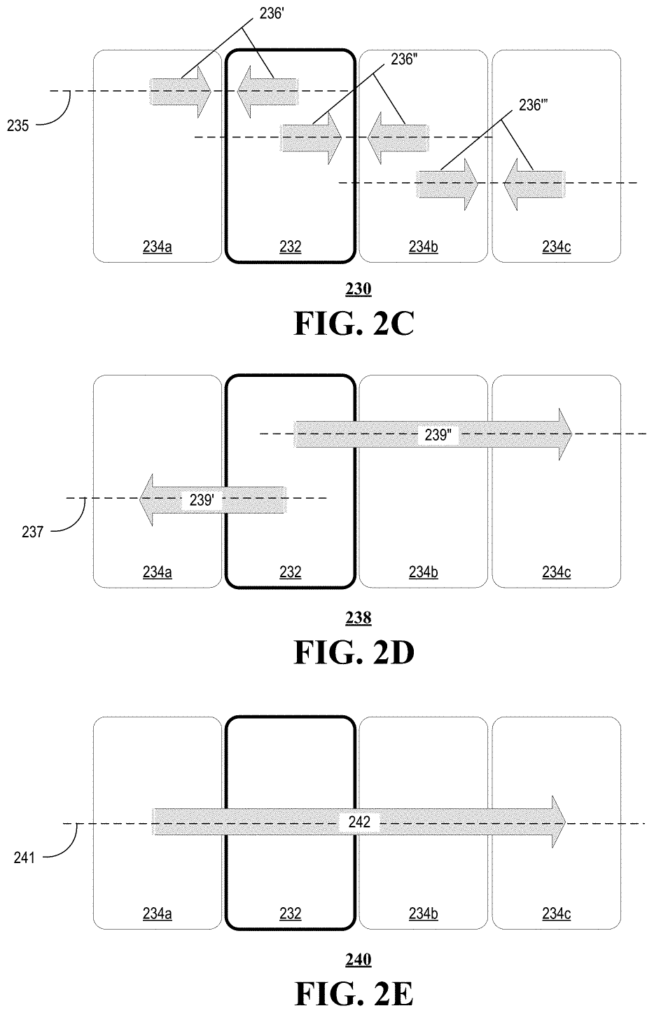

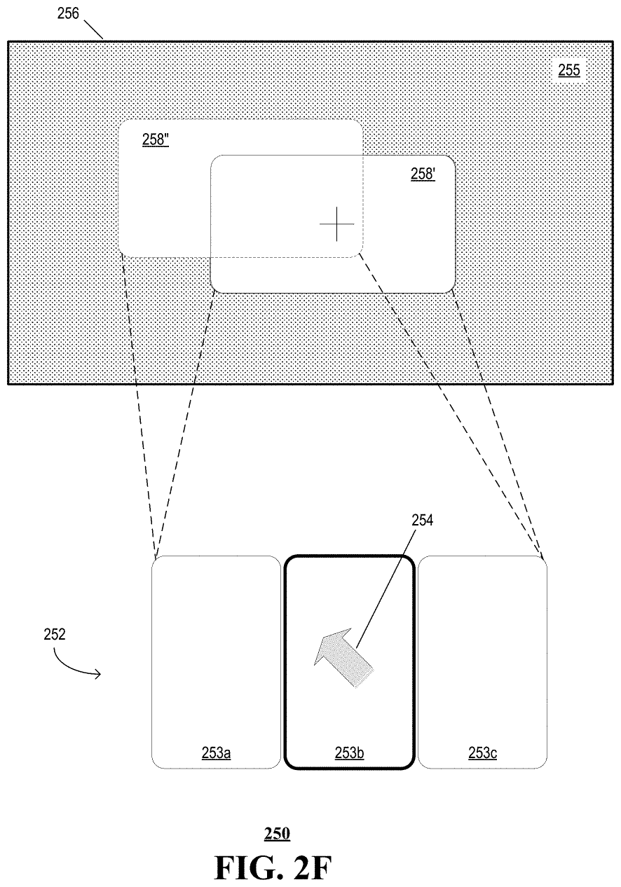

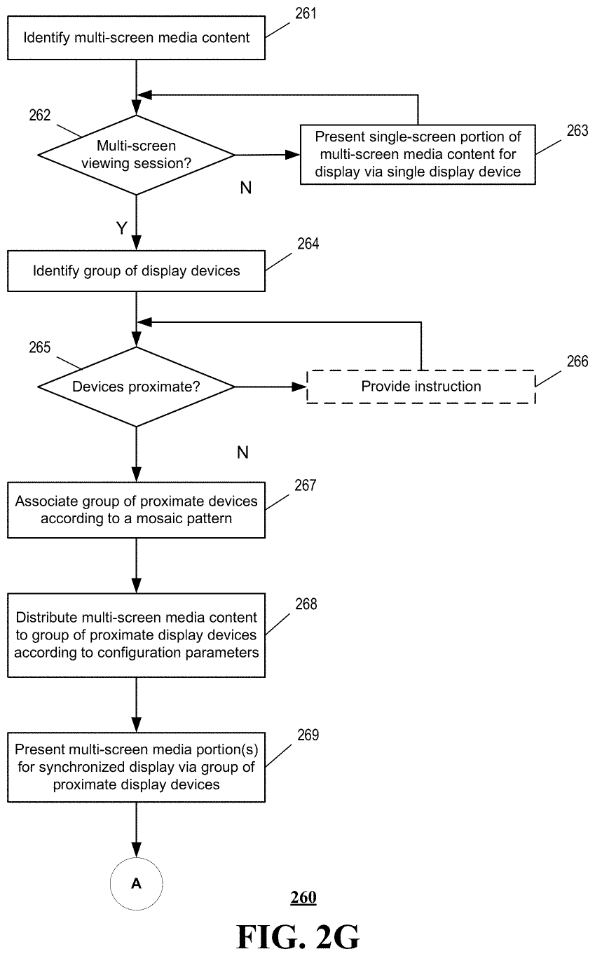

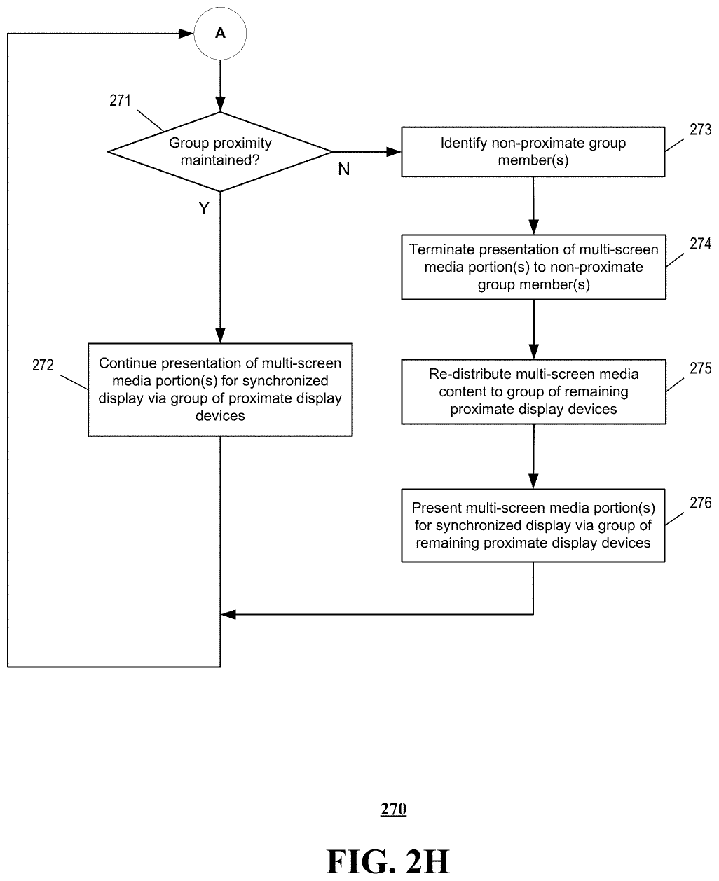

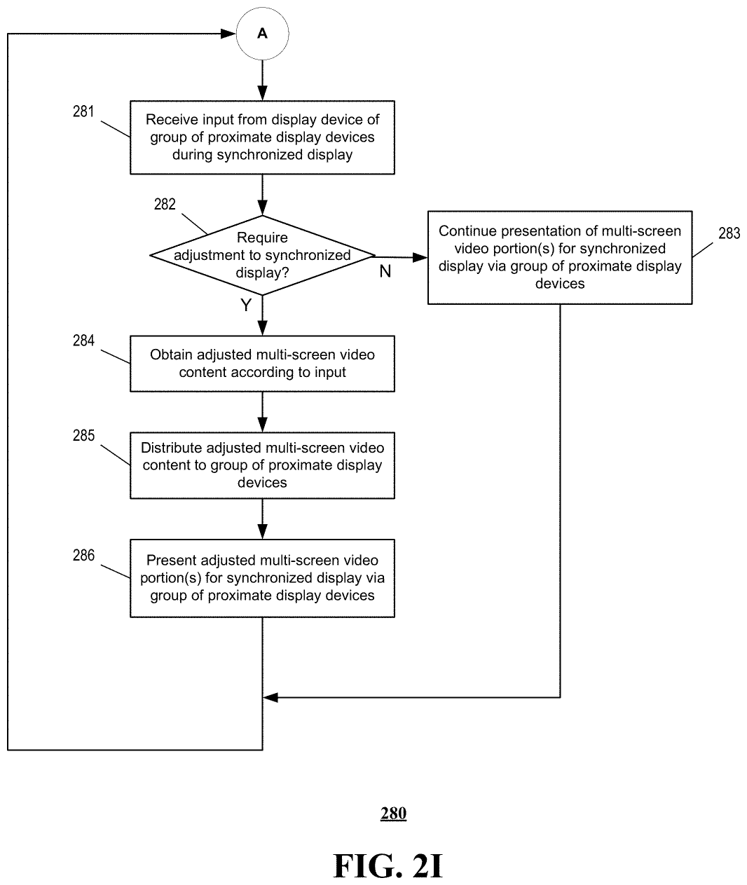

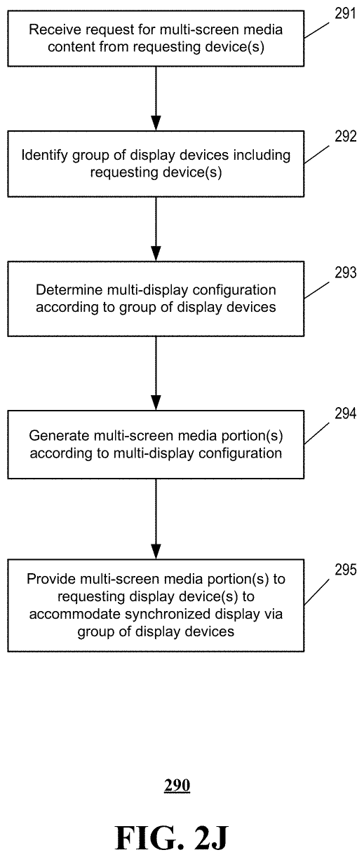

FIG. 2A is a block diagram illustrating an example, non-limiting embodiment of an extendable viewing system 200 functioning within the system 100 of FIG. 1 in accordance with various aspects described herein. The example extendable viewing system 200 includes a content delivery server 202 in communication with a media content repository 204. The content delivery server 202 is also in communication with one or more mobile devices 206, 222a, 222b, 222c via a communications network 208. The media content may include, without limitation, any of the various media types disclosed herein and otherwise known to those skilled in the art. For the purposes of illustration, the media content includes video content.

In at least some embodiments, the video content may include a video file according to a video file format. It is also understood that in at least some embodiments, the video content may be encoded. Encoding may be used for storage and/or file transfer efficiency, error detection and/or correction, and so on. The content deliver server 202 and/or the mobile display devices 206, 222a, 222b, 222c may include an encoder and/or decoder, often referred to as a codec, to encode and/or decode one or more parts of a media content item. Example codes include, without limitation, HEVC/H.265, H.264, MPEG-4 and DivX.

Video formats include, without limitation, formats according to any of the Moving Picture Experts Group (MPEG) standards, e.g., MPEG-1, MPEG-2, MPEG-4, the Audio Video Interleave (AVI) format, the MOV format, e.g., for use with a QuickTime® player, the FLV format, e.g., for use with Adobe Inc. Flash® player, and the Windows® Media® videos (WMV) format. It is understood that a video file format may have multiple portions, such as video portion, but also the audio streams and additional information such as optional subtitles, metadata, in some cases menu structures. At least some of the video formats employ a container that may include one or more of the parts of video content.

Video content generally includes a sequence of still images that when presented in rapid succession via a display device present the illusion of moving images. The video frames may have one or more of an overall frame size, an overall aspect ratio, a resolution, a color space and so on. According to the illustrated embodiment, a portion of a media content item, e.g., a video chunk 210, includes a time sequence of video frames 212. In particular, the video frames 212 may be formatted and/or otherwise adapted to have an initial viewing portion and an extended viewing portion. The initial, or primary viewing portion may be adapted for presentation by a single display device. The parameters of the primary viewing portion may be substantially fixed, or vary according to one or more considerations. Considerations may include, without limitation a type of display device, e.g., a mobile phone vs. a tablet or laptop, a resolution as may be determined by a device capability, by an available bandwidth, by network conditions, by subscription level, a user preference, an aspect ratio, a device orientation, e.g., portrait vs. landscape, any panning and/or zoom as may be applied, and so on. Significantly, there remains at least an observable portion of the video frame 212 that is not viewable and/or otherwise accessible by a single display device.

Such restrictions may be imposed in an effort to encourage multi-device participation and/or cooperation to access one or more other extended viewable regions, without consideration of any display device restrictions. In at least some embodiments, extended viewing regions of the video frames 212 may be applied in a hierarchical manner, e.g., providing access to a first restricted extended viewing region only when using more than one display, providing access to a second restricted extended viewing region only when using more than two displays, and so on. Such permissible and/or restricted regions of a video frame 212 may be fixed according to the video frame, e.g., permitting a central region to be viewed, while imposing restrictions on lateral regions to either side of the central region, e.g., to limit viewing of the lateral regions by a single display device. The size and/or shape of the permissible region(s) may be fixed according to video frame parameters, e.g., a frame size and/or aspect ratio. Alternatively or in addition, the size and/or shape of the permissible region(s) may be determined at least in part according to a device configuration parameter, such as a device type, a screen size, a display aspect ratio, a device orientation, and the like.

Continuing with the illustrative embodiment, the system 100 includes a primary display device 206. One or more configuration parameters may be associated with primary display device 206. For example, the primary display device 206 may have a screen size and/or a screen resolution and/or an orientation. According to the illustrative example, the primary display device 206 is presented according to a portrait orientation. The display device orientation may be determined by an internal sensor of the primary display device 206, such as one or more accelerometers, a compass, a location receiver, and the like. Alternatively or in addition, the orientation may be defined according to a user input, e.g., a user identification or preference for portrait orientation. Other orientations may include, without limitation, a landscape orientation.

The primary display device 206 may be associated with a media content item, e.g., according to user input, such as a user selection of a particular media content item from among a listing of multiple media content items, such as in a video on demand catalogue and/or a channel selection from among a lineup of channels, e.g., according to an electronic programming guide. Information, including one or more of the device configuration parameters, and/or user configuration inputs, and/or media content selections may be provided to the content delivery server 202. The content delivery server 202, in turn, may obtain media content, such as the illustrative video chunk 210 from the media content repository 204. In at least some embodiments, the content delivery server 202 may identify a segment, or a portion, e.g., a spatial region, of a video frame 212 of the video chunk 210 to be presented upon a screen of the primary display device 206. According to the illustrative example, the content delivery server may identify a viewport 216 according to one or more of the device configuration parameters. The content delivery server 202 may overlay the viewport 216 upon at least one video frame 212 of the video chunk to identify a portion of the video frame to be provided for presentation at the primary display device 206. In this example, the FoV 216 of the primary display device 206 overlays a central portion of the video frame 212 as indicated by a frame center indicator 220.

It is understood that in at least some instances, a transformation may be applied to content of the video frame 212 to adapt the video frame 212, or portion thereof, according to a presentation format employed by the primary display device 206. For example, spherical video content may map spherically captured content to a 2D video frame according to a spatial transformation. Another transformation may be applied during presentation of a portion of the spherical video frame, to support a user application, such as immersive video. Thus, although the example FoV 216 is illustrated as a rectangle generally corresponding to the size and/or shape of a screen of the primary display device 206, it is understood that the FoV 216 and/or other projection as may be utilized to identify a presentation portion of the video frame 212 may have a different shape, e.g., determined at least in part by one or more of the spatial transformations.

According to the illustrative embodiment, a first subordinate or companion display device 222a is identified. To facilitate an extended viewing session, the first companion display device 222a is moved into position substantially adjacent to the primary mobile display device 206. The illustrative example has the first companion display device 222a moved toward a left edge of the primary display device 206. The first companion display device 222a is also shown in a portrait orientation, however, it is understood that other orientations may be utilized. For example, the first companion display device 222a may employ an orientation that matches that of the primary display device 206. Alternatively or in addition, the first companion display device 222a may employ an orientation that differs from the primary display device 206. For example, the first companion display device 222a may utilize a landscape orientation, while the primary display device 206 utilizes a portrait orientation.

In at least some embodiments, configuration parameters of the first companion display device 222a may be communicated to the content delivery server 202. The parameters may be provided by the primary device 206, e.g., with the primary display device 206 obtaining the configuration parameters from the first companion display device 222a via a communication link, such as a first wireless link 224a, e.g., a first local area network. The content delivery server 202, in turn, may identify a segment, or a portion, e.g., a spatial region, of the video frame 212, e.g., a viewport 218a, according to one or more of the device configuration parameters of the first companion display device 222a. The content delivery server 202 may overlay the viewport 218a upon the video frame 212 to identify a corresponding portion of the video frame 212 to be provided for presentation via a screen of the first companion display device 222a. In this example, the FoV 218a of the first companion display device 222a overlays a region adjacent to a left edge of the FoV 216 of the primary display device 206. In general, a spatial orientation of the primary and first companion display devices 206, 222a may be referred to as a mosaic or a mosaic pattern. According to the illustrative example, the primary and first companion FoVs 216, 218a are arranged in a manner corresponding to the mosaic patter of the devices 206, 222a.

It is envisioned further that one or more other companion display devices may be identified and/or arranged, and/or configured in a like manner to the first companion display device 222a. According to the illustrative example, a second companion display device 222b may be identified and arranged along a right edge of the primary display device 206. The example orientation of the second primary display device 222b is also in the portrait orientation, although other orientations may be possible. Configuration parameters, e.g., including the orientation, may be provided to the content delivery server 202 to facilitate identification of a second companion FoV 218b that may be applied to the video frame 212 to obtain a corresponding portion of the video frame 212 to be presented at a screen of the second companion display device 222b. Still further mobile display devices, e.g., a third companion display device 222c, may be added to the mosaic pattern and configured in a like manner to permit a shared expanded view of an expanded region of the video frame 212 otherwise inaccessible by the primary display device 206 alone.

In at least some embodiments, the content delivery server 202 provides a primary portion of the video frame 212, e.g., that portion overlapped by the primary FoV 216, to the primary display device via the communication network 208. The content delivery server 202 may provide a first companion portion of the video frame 212, e.g., that portion overlapped by the first companion FoV 218a, for presentation via the first companion display device 222a. In some embodiments, the first companion portion may be communicated directly to the first companion display device 222a, e.g., via the communication network. Alternatively or in addition, at least a portion of first companion portion may be provided to the first companion display device 222a via one or more of the other mobile display devices participating in a shared expanded viewing session. For example, the content delivery server 202 may provide both the primary and first companion portions of the video frame 212 to the primary display device 206, which, in turn, provides the received first companion portion to the first companion display device 222a. Other portions may be provided to other companion display devices 222b, 222c, in a similar manner. For example, the content delivery server 202 may provide a third companion portion to the primary display device 206, which in turn provides that portion to the third companion display device 222c via the second companion display device 222b. More generally, a peer-to-peer network may be utilized that includes one or more of the primary and/or companion display devices 206, 222a, 222b, 222c alone or in combination with one or more other devices, to facilitate communication of configuration parameters, e.g., to the content delivery server 202 and to facilitate transfer of one or more of the portions of the video frame, such that the appropriate portions are delivered to the appropriate devices in a timely manner to permit a substantially coherent and logical presentation of the extended view of the media content item.

Communications between one or more of the primary display device 206 and/or the companion display devices 222a, 222b, 222c may occur via a wireless communication link, e.g., according to a wireless communication protocol. Example protocols may include, without limitation a WiFi communication protocol, a BlueTooth® communication protocol, a near field communication (NFC) protocol, and the like. NFC protocols may apply to devices 206, 222a, 222b, 222c that are separated less than some minimum distance, e.g., about 4 cm (1.5 inches) or less. Modes of communications between and among one or more of the devices 206, 222a, 222b, 222c may be adaptable. Consider communications in which all companion portions are routed through a primary display device. Should, a communication link between the content delivery server 202 and the primary display device 206 become limited and/or otherwise compromised, some or all of the portions of the vide frame may be routed to one or more of the companion display devices 222a, 222b, 222c and distributed therefrom to other devices as necessary.

According to the illustrative embodiment, a first wireless link 224a is established between the primary display device 206 and the first companion display device 222a. A second wireless link 224b is established between the primary display device 206 and the second companion display device 222b, and a third wireless link 224c is established between the primary display device 206 and the third companion display device 222c. Alternatively or in addition, other communication links may be established between one or more and up to all of the participating display devices 206, 222a, 222b, 222c.

In at least some embodiments, a message may be provided to the primary display device 206 for presentation to a user via a user interface, such as a display screen of the primary display device 206. The message may invite a user to participate in a shared viewing experience, e.g., by advertising shared content and/or by indicating that a selected media content item is available in a shared viewing mode to permit access to extended content not otherwise available when using the primary display device 206 alone. Other messages 226″, 226′″ may be provided for display upon user interfaces, e.g., display screens, of one or more of the companion display devices 222a, 222b, e.g., inviting them to participate in a shared, expanded viewing experience with the primary display device 206, and perhaps one or more other companion display devices as may have already accepted such invitations.

Such messages 226′, 226″, 226′″ (generally 226) may be adapted for other purposes, such as providing advertising content, and/or user interface features, such as buttons, pulldown lists, and the like. In at least some embodiments, one or more of the messages 226 may provide an indication of a mosaic pattern. The mosaic pattern may indicate optional patterns, e.g., as may have been predetermined according to a formatting of the video frame 212, for example, to provide an indication of available extended content and/or suggested patters according to a number of devices. Consider a user indicating that two smartphones will participate. A mosaic patter may indicate whether a portrait or a landscape arrangement would be recommended.

Considering that multiple devices 206, 222a, 222b, 222c may be configured to present a coherent and logical arrangement of portions of a common video frame 212 to provide an extended view, the devices would most likely work best if provided in a close proximity of each other, e.g., abutting along adjacent edges. To this end, one or more sensors may be provided and/or utilized to recognize devices in close proximity, e.g., within a few cm, or about 1.5 inches or less. Sensors may include, without limitation, proximity sensors, e.g., based on one or more of a near field communication system, a near field sensor, a location receiver, a gyroscope, a compass, and the like. Other indications of proximity may include user input, such as a simultaneous and/or sequential gesture across two or more touch screen displays of the participating devices 206, 222a, 222b, 222c.

By way of example, a first portion of a first user input 227′ may include a finger touch, a gesture and/or a user selection of a graphical button of a touch screen of the primary display device 206. A corresponding portion of the first user input 227″ may include a finger touch, a gesture and/or a user selection of a graphical button of a touch screen of the first companion display device 222a. The first user input 227′, 227″ may signify an association between the primary display device 206 and the first companion display device 222a, possibly indicating a proximate arrangement, e.g., an abutting edge of the screen or device. Likewise, a first portion of a second user input 228′ may include a finger touch, a gesture and/or a user selection of a graphical button of a touch screen of the primary display device 206, with a corresponding portion of the second user input 228″ including a finger touch, a gesture and/or a user selection of a graphical button of a touch screen of the second companion display device 222b. The second user input 228′, 228″ may signify an association between the primary display device 206 and the second companion display device 222b, possibly indicating a proximate arrangement, e.g., an abutting edge of the screen or device. Similar user inputs may be applied to one or more other devices participating in the shared expanded viewing session.

In at least some embodiments, shared expanded viewing may be permissible only when the participating devices are sufficiently close, e.g., proximate or substantially touching. For example, a shared presentation may commence only after the participating display devices 206, 222a, 222b, 222c are in a proximate relationship. Alternatively or in addition, a shared experience, once commenced, may be paused, terminated and/or adjusted in response to a change in the proximate arrangement. For example if one of the participating devices, e.g., the third companion display device 222c is participating in a mosaic pattern, but moves away from the other devices 206, 222a, 222b, a notification may be provided to the third companion display device 222c and/or to one or more of the other participating devices 206, 222a, 222b. The notification may suggest that the third companion display device 222c be returned so as to continue with the originally configured expanded viewing presentation. Alternatively, the notification may query whether the presentation should be paused and/or terminated, or continued according to an adjusted mosaic pattern without the third companion display device 222c.

To ensure an optimal viewing experience, presentations among the various participating mobile display devices 206, 222a, 222b, 222c should be synchronized. To this end, it is envisioned that in at least some embodiments, a synchronization pulse, mark or other suitable indicator is shared between the participating mobile display devices to facilitate presentation of the shared content among a multiplicity of participating screens. Alternatively or in addition, a synchronization pulse, mark or other suitable indicator may be suppled by another entity, such as a network clock, a signal received from another device, such as the content delivery server 202 and the like.

FIG. 2B is a block diagram illustrating an example, non-limiting embodiment of a system architecture 205 functioning within the communication networks 100, 200 of FIGS. 1 and 2A, and adapted to facilitate multi-screen, or mosaic, extended-view presentations in accordance with various aspects described herein. The example system architecture 205 includes a media content server 201, a first communication network 203, a primary mobile device 209 and secondary mobile devices 211a, 211b. The media content source is in communication with the primary mobile device 209 via the first communication network 203. The primary mobile device 209, in turn, is in communication with a first one of the secondary mobile devices 211a via a first local communication channel or network 213a and a second one of the secondary mobile devices 211b via a second local communication channel or network 213b.

The media content server 201 may include any of the example media content repositories 204, the media content servers 202 (FIG. 2A) and/or other server and/or storage devices disclosed herein and/or otherwise adapted to source media content for presentation on a display device, such as the primary mobile device 209 and/or the secondary mobile devices 211a, 211b. The mobile devices 209, 211a, 211b may include any of the example mobile devices disclosed herein, or otherwise adapted for presentation of the media content, such as mobile phones, tablet computers, laptop computers, smart televisions and the like.

According to the illustrative embodiment, the primary mobile device 209 is physically separated from a first one of the secondary mobile devices 211a, by a first distance, d₁, while the primary mobile device 209 is also physically separated from a second one of the secondary mobile devices 211b, by a second distance, d₂, For those applications in which a separation threshold, dₜₕ, is utilized, a participation in any multi-screen, or mosaic, extended-view presentation, may be restricted to configurations in which the distances are less than the separation threshold, i.e., d₁<dₜₕ and d₂<dₜₕ. In at least some embodiments, movement of one or more of the devices may alter a respective separation distance. At least one of the devices, e.g., the primary mobile device 209 may be adapted to detect such separations exceeding a threshold value, e.g., based on a near field communication sensor.

The first and second communication networks 203, 213a, 213b may include any combination of wired and/or wireless networks, including the various example networks disclosed herein or otherwise adapted for transporting media content. The first communication network 203 may also include any combination of a wide area network, e.g., the Internet, a metropolitan area network, a private communication network, a cable service provider network, a local area network, e.g., Ethernet, a personal area network and so on. One or more elements of the first and second communication networks 203, 213a, 213b may include a wireless network, e.g., a mobile cellular network, a WiFi network, a Bluetooth network, and the like. In at least one embodiment, the first communication network 203 includes a wide area network, such as the Internet and/or a cable service provider network, while the second communication network 213a, 213b includes a peer-to-peer network. The peer-to-peer network may be accommodated by any of the aforementioned local area network and/or personal area networks, e.g., according to Bluetooth and/or WiFi protocols. In at least some embodiments, at least one of the second communication networks 213a, 213b, may utilize a near field communication protocol.

According to the illustrative embodiment, media content 207 is transported from the media content server 201 to the primary mobile device 209. The media content 207 includes extended video frame content adapted for presentation across multiple display devices arranged in close proximity so as to form a mosaic display. Accordingly, the media content 207 may include a sequence of video frames. The sequence of video frames may include encoded content, e.g., encoded according to an industry standard, such as any of the MPEG standards. At least some video frames of the media content 207 may include a first portion, e.g., a first spatial segment adapted for display or presentation at one of the mobile devices 209, 211a, 211b and one or more other portions, e.g., spatial segments, adapted for display or presentation on one or more other ones of the mobile devices 209, 211a, 211b. In particular, when the different portions of the sequence of vide frames are displayed or presented upon their respective mobile devices 209, 211a, 211b, the collective display or presentation provides a cohesive display or presentation of an extended-view of the media content 207, e.g., providing access to video content not otherwise available using less than an intended number and/or configuration of display devices.

In some embodiments, the media content server 201 configures and/or otherwise adapts the media content according to the mosaic configuration, or array, of the display devices, e.g., according to their number, their orientations, their collective arrangement, resolutions, display types, and so on. By way of example, configuration of the media content 207 may include preparation of a sequence of composite video frames, e.g., each sequence of composite video frame including content portions intended for presentation by all of the participating mobile devices 209, 211a, 211b. Alternatively or in addition, the configuration of the media content 207 may include preparation of separate sequences of video frames, e.g., a different sequence of video frames for each of the participating mobile devices 209, 211a, 211b. In at least some embodiments, the media content server 201 obtains a map of relative locations of the display devices in the array. The media content server 201 may then break down a target image or video to be displayed into image or video portions correlating to the map of the identified display devices, such that each portion of the image or video when displayed according to the map, provides an overall mosaic of the extended view image or video.

The suitably configured media content 207, e.g., adapted for presentation by the three mobile devices 209, 211a, 211b, is transported to the primary mobile device 209 via the first communication network 203. The primary mobile device 209, in turn, forwards at least a portion 215a, 215b of the received media content 207 to each of the secondary mobile devices 211a, 211b via the second communication network 213a, 213b. To the extent the primary mobile device 209 receives a sequence of composite video frames, the primary mobile device 209 adapts the sequence of composite video frames to extract separate sequences of video frames for each of the participating mobile devices 209, 211a, 211b. The primary mobile device 209 retains a separated sequence of the video frames intended for itself and forwards respective separated sequences of the video frames 215a, 215b to each of the secondary mobile devices 211a, 211b, via the second network 213a, 213b, To the extent the primary mobile device 209 receives separate sequences of video frames, the primary mobile device 209 identifies the intended recipient mobile devices, retains a separate sequence intended for itself and forwarding the respective separate sequences of video frames to each of the secondary mobile devices 211a, 211b. Each of the participating mobile devices 209, 211a, 211b, having received its respective portion of the sequence of video frames, may display or present that portion upon its respective display screen. A display of the respective video content portions according to the predetermined arrangement of the display screens provides the intended mosaic presentation of the extended media content.

In at least some embodiments, one or more of the mobile devices 209, 211a, 211b may be rearranged in a manner that preserves any maximum separation thresholds, but forming a different or revised mosaic pattern. To the extent such a reconfiguration is defined, detected and/or otherwise determined, the reconfiguration of the mosaic pattern may be communicated to one or more of the primary mobile device 209 and/or the media content server 201. The media content server 201, in turn, may reconfigure and/or otherwise further adapt the media content according to the revised mosaic configuration. The revised mosaic pattern may include one or more of a change in orientation, order, proximity, alignment and so on. For example, three mobile devices 209, 211a, 211b arranged in portrait orientation along a common axis may be rearranged in a landscape orientation along the same axis. It is envisioned that such rearrangement of the group of mobile devices 209, 211a, 211b may include an addition and/or deletion of one or more devices. Preferably, such reconfigurations are accommodated during a presentation of the media content, minimizing and/or eliminating any delay. Additional screens generally enlarge a canvass adapted to bring additional hidden content and/or other enriching experiences into view that could not previously be seen, thus creating added value when additional devices are paired into the “party” of participating viewers.

In at least some embodiments, once a user chooses an extended-view video, e.g., using a multi-screen, or mosaic, extended-view presentation mobile app, the mobile device will start downloading the media content and continue downloading during a multi display-device setup procedure. Once at least a portion of the extended-view media content is downloaded and paired with the other devices, the receiving mobile device will broadcast at least a portion of the received content from the receiving mobile device to other configured mobile devices, e.g., using a peer-to-peer technology, so that the user will not have to wait. For example, a first mobile device begins downloading media content and while downloading, synchronizes with one or more other mobile devices and distributing at least portions of the received media content from the first mobile device to the other(s). Consequently, there is no need for each of the mobile devices to download media content from the media content server. Such a parallel process facilitates media content access, formatting, distribution and presentation in a relatively brief time to initiate a mosaic presentation with minimal delay.

FIG. 2C is a block diagram illustrating an example, non-limiting embodiment of an extendable viewing system 230 functioning within the communication network of FIGS. 1 and 2A in accordance with various aspects described herein. The system 230 includes a first mobile display device, e.g., a first mobile phone 232, sometime referred to as an initial or a primary mobile display device, e.g., a primary mobile phone 232, and three additional mobile display devices, e.g., mobile phones, 234a, 234b, 234c (generally 234), sometimes referred to as subsequent or secondary mobile display devices 234. The mobile phones 232, 234 are positioned in an illustrative proximate arrangement or group, in which all the phones are aligned along their minor axis, e.g., side-by-side, each in a portrait orientation. In the particular illustration, the primary and additional mobile phones 232, 234 are substantially touching along their adjacent edges.

According to an example association process, two or more of the mobile phones 232, 234 may be associated with each other. The associations may be made according to user input at one or more of the mobile phones 232, 234. For example, one or more gestures may be received via touchscreen interfaces of the mobile phones 232, 234. According to a first illustrative gesture, a pinching motion may be made, e.g., using a thumb and a forefinger according to the first pair of arrows 236′. The pinching gesture may result in substantially simultaneous inputs, e.g., according to each respective arrow of the pair of arrows 236′, with one input received at each of a first pair of mobile phones, i.e., the primary mobile phone 232 and a first adjacent mobile phone 234a. At least one of the mobile phones, e.g., the first adjacent mobile phone 234a, may share an occurrence of the gesture input 236′ with another mobile phone, e.g., the primary mobile phone 232. The sharing may occur according to a predetermined arrangement, e.g., all inputs being shared with one device, e.g., the primary mobile phone 232. Alternatively or in addition, the predetermined arrangement may be a mutual sharing between adjacent devices.

In at least some embodiments, a condition of adjacency between two devices may be determined according to an observation of substantially simultaneous gesture inputs, e.g., as indicated by the example arrows of a first gesture input 236′. By simply noting the simultaneous occurrence of multiple gestures as well as one or more of their respective devices, locations and/or directions, the system 230 may determine a spatial relationship between multiple display devices. For example, the first gesture input 236′ may be interpreted by the system 230 to infer that the two devices 232, 234a are adjacent, and that they are both in portrait orientation, with a left edge of the primary mobile phone 232 being substantially adjacent to a right edge of the first adjacent mobile phone 234a.

By observing a location of the gesture on each display device 232, 234a, the system 230 may determine a relative alignment of the devices 232, 234 along their abutting edges. According to the illustrative example, the first gesture input 236a occurs along a top portion of each display device 232, 234a, e.g., along a gesture axis 235. Accordingly, the system 230 may infer that the devices 232, 234a are aligned along the observed gesture axis 235.

According to the illustrative example, a second gesture input 236″ may be observed at the primary mobile phone 232 and a second adjacent mobile phone 234b. A relative orientation, abutting relationship and/or relative alignment may be inferred by the system 230 based on the second gesture input 236″. Likewise, a third gesture input 236′″ may be observed at the second adjacent mobile phone 234b and a third adjacent mobile phone 234c. Once again, a relative orientation, abutting relationship and/or relative alignment of the two devices 234b, 234c may be inferred by the system 230 based on the second gesture input 236″. The system may evaluate gesture inputs from among the group of devices 232, 234 to determine an overall arrangement of the four devices 232, 234, as illustrated. Supporting calculations and/or logic may be incorporated on one of the devices, e.g., the primary mobile phone 232, or among multiple devices, e.g., each of the proximate devices 232, 234. Alternatively or in addition, at least a portion of the calculations and/or logic may be applied by another device, e.g., an application server in communication with one or more of the mobile display devices 232, 234.

In at least some embodiments, an arrangement of a group of proximate mobile display devices 232, 234 may be determined according to one or more sensors of the mobile display devices 232, 234. For examples, input signals from one or more of internal gyroscopes, compasses, and/or position sensors may be used to determine an orientation of one or more of the display devices, e.g., to distinguish between portrait and landscape orientations and/or to determine between horizontal and/or vertical orientations. In at least some embodiments, one or more of the mobile display devices 232, 234 may be equipped with a proximity sensor, e.g., a nearfield sensor, to detect proximity to another object, such as another mobile display device 232, 234.

FIG. 2D is a block diagram illustrating an example, non-limiting embodiment of an extendable viewing system 238 functioning within the communication network of FIGS. 1 and 2A in accordance with various aspects described herein. The extendable viewing system 238 includes a similar arrangement of four mobile phones 232, 234 positioned, side-by-side, as in the previous example. According to this example, the system 238 utilizes a different gesture for alignment purposes. Namely, instead of a pinching gesture 236′ as in the preceding example, the extendable viewing system 238 operates according to a swiping gesture 239′, 239″ (generally 239).

The example first swiping gesture 239′ begins at a first screen of the primary mobile phone 232, and progresses towards a left edge of the first screen. The same swipe traverses the abutting edge between the primary mobile phone 232 and the first adjacent mobile phone 234a, and extends onto a second screen of the first adjacent mobile phone 234a. The extendable viewing system 238 may observe a sequence in the swiping gesture, e.g., that it exists substantially on only one device at a time, and that it extends sequentially towards another device within a minimal time delay between portions of the same swipe 239′. The extendable viewing system 238 may conclude from the sequential relationships between swipe portions on the two mobile phones 232, 234a, that they are, in fact, segments of the same swiping gesture 239′.

The extendable viewing system 238 may infer from the sequence of the swipe segments that two devices are adjacent. The extendable viewing system 238 may infer further from respective edges traversed by the related sequential segments of the swipe gesture 239′ that the edges are abutting edges. The extendable viewing system 238 may infer still further from positions of the respective segments of the swipe, an alignment of the devices, e.g., along the swipe axis 237. Accordingly, the extendable viewing system 238 may infer that the two devices receiving the first swiping gesture input 239′ are associated in a particular arrangement, e.g., adjacent along the long edge of the screen. Any of the various screen associations and/or arrangements disclosed herein may be referred to as mosaics or mosaic patterns, or mosaic arrangements of displays.

According to the illustrative example, a second swipe extends across three screens of three different mobile phones 232, 234b, 234c. The extendable viewing system 238 may apply similar techniques to identify that gesture occurring on the three screens in a sequential nature and within some minimal delay or time limit, e.g., less than 1 second, or a fraction of a second, e.g., 0.5 sec, 0.2 sec or less, are related to one swiping gesture 239″. The swipe segments may be interpreted as swipes, having a direction and extending from and/or towards edges of the respective mobile phones 232, 234b, 234c. Consequently, a single swiping gesture 239″ across more than two display screens may facilitate an association and/or a grouping and/or an arrangement of the screens actuated by the single swiping gesture 239″. According to the illustrative example, the swiping gestures 239′, 239″ may originate and/or terminate at a common mobile display device, such as the example primary mobile phone 232.

It is worth noting here that the pinch axes 235 and or swipe aces 237 may be used to infer a relative alignment of adjacent display devices. However, in at least some embodiments, the pinch and/or swipe gestures 236, 239 may be evaluated without respect to the relative locations on the screens, the extendable viewing system 230, 238 instead presuming an alignment of adjacent display devices. For example, the alignment may be presumed along an approximate centerline of each device and/or along one or more edges, such as a top edge and/or a bottom edge, without the need for determining gesture axes 235, 237. If the alignment is not exact, the user may provide any refining alignment after observing presentations of the different portions of the extended media content item on the respective displays.

FIG. 2E is a block diagram illustrating another example, non-limiting embodiment of an extendable viewing system 240 functioning within the communication network of FIGS. 1 and 2A in accordance with various aspects described herein. According to the illustrative example, associations, configurations and/or alignments of the mobile phones 232, 234 were accomplished with swipe gesture inputs 239 originating from a primary mobile phone 232. The illustrative extendable viewing system 240 includes a similar arrangement of four mobile phones 232, 234 positioned, side-by-side, as in the previous examples. According to this example, the extendable viewing system 240 utilizes a single swiping gesture 242. The swiping gesture 241 may originate at one of the end devices 234a of the linear arrangement and extend across the remaining mobile phones 232, 234b, 234c.

Detection of the swipe gesture 242 may occur as described above. For example, a swipe gesture is observed at each of the different mobile phones 232, 234, within a minimal time delay. In at least some embodiments, a particular sequence of the swipe segments is determined, e.g., with the first swipe segment at the leftmost device 234a occurring before swipe segments at any of the other devices. A second swipe segment is observed at the primary device 233 after observation of the first swipe segment and before any of the subsequent swipe segments at the rightmost devices 234b, 234c.

A sequence of the swipes may be sufficient to determine a linear arrangement of the mobile phones 232, 234. According to any substantial delay between swipe segments, e.g., beyond a minimal threshold value, e.g., greater than a fraction of a second, or greater than a second or more, the extendable viewing system 240 may infer that devices are not sufficiently close for an intended viewing pattern. In such instances, instruction may be provided to a user to reposition the devices, ensuring that the participating devices are abutting in a mosaic pattern. The user may then be instructed to repeat the gesture to ensure that all delays between participating devices are sufficiently small, indicating adjacent relationships.

FIG. 2F is a block diagram illustrating an example, non-limiting embodiment of an extendable viewing system 250 functioning within the communication network of FIGS. 1 and 2A in accordance with various aspects described herein. According to the example, three mobile display devices 253a, 253b, 253c (generally 253), in portrait orientation are arranged in a linear fashion along their minor axes, e.g., abutting along their respective long edges. The associated devices 253 may be referred to collectively as an associated group of mobile display devices 252. An example extended view video frame 256 is also illustrated having a viewable portion 255 or region that is greater than that observable by any single one of the display devices 253. It is envisioned that operational restrictions may be applied to ensure that at least some regions of the extended view video frame 256 are only accessible when multiple display devices 253 are operating according to a mosaic pattern.

Each of the display device 253 has a respective FoV, e.g., according to configuration parameters of the device. A collective FoV 258′ may be established that corresponds to a combination of the respective FoVs of the individual mobile devices 253. The collective FoV 258′ may have a corresponding size and/or shape determined at least in part to the mosaic pattern of a group arrangement of mobile devices 253. The collective, aggregate or combined FoV 258′ is illustrated at a first position, substantially centered within the extend view video frame 256. An overlapping portion of the extended view video frame 256 that falls within a shadow of the combined FoV 258′ may be provided to the group of mobile display devices 252 to permit display of the provided portion across display screens of the group of display devices 253.

It is envisioned that in at least some embodiments, the size, location and/or orientation of the combined FoV 258′ may be adjusted. Adjustment may occur during a pre-configuration period, e.g., before active viewing of the extended view media content item begins. In at least some embodiments, an adjustment may occur during a presentation of the extended view media content item. For example, a user may choose to view more content along an upper left region of the extended view video frame 256. To accomplish this, a user may provide an input that initiates and/or otherwise results in a repositioning of the aggregate FoV 258′ to a second position overlapping more of an upper left portion of the extended view video frame 256. The readjusted FoV 258″ is illustrated by dashed lines corresponding to an adjusted portion of the extended view video frame 256 that is provided to the group of mobile devices 253, in place of the originally provided portion, to permit presentation of the adjusted portion across the display screens of the group of mobile display devices 252.

According to the illustrative example, the repositioning of the aggregate FoV 258″ occurs responsive to a user input obtained from a user interface of one of the group of mobile devices 253, e.g., a primary or controlling mobile device 253b. For example, a user may provide a swipe gesture 254 at a touch screen of the central mobile device 253b along a direction as indicated, i.e., swiping up and to the left. In response to the swipe gesture 254, a content formatting and/or delivery server 180, 202 (FIGS. 1-2A), may adjust the FoV 258″ and provide video content from a region of the extended view video frame 256 overlapped by the adjusted aggregate FoV 258″. In some embodiments, user input may only be accepted from one mobile display devices 252 of the group of mobile devices 251. In other embodiments, user input may be accepted from more than one of the mobile display devices 252, e.g., any one of the participating mobile display devices 252.

Although the example user inputs are described as gestures made upon a touch screen user interface, it is envisioned that other modes of input may be provided. For example, a user may operate a pointing device, such as a cursor, a mouse, a touchpad, a trackball, a joystick, and the like. Similarly, although a repositioning gesture was described shifting a first viewed region to an adjusted view region corresponding to the user input, it is envisioned that other viewing transformations may be applied according to similar inputs. For example, a zoom function may be applied, effectively enlarging and/or reducing a size of the adjusted FoV 258′ according to a pinch type of gesture, or operation of a graphical icon corresponding to zoom, etc. Other transformations may include rotations that may be initiated by suitable forms of user input. In at least some embodiments, a user input at one mobile device, e.g., the central device 253b, provides an adjustment of presentations at all of the mobile devices 253 of the group of mobile display devices 252.

FIG. 2G depicts an illustrative embodiment of a multi-screen viewing process 260 in accordance with various aspects described herein. The process 260 includes identifying multi-screen media content at 261. The multi-screen media content may include any of the various extended view content types disclosed herein, such as pre-programmed video content, on-demand video content, live video content, pre-recorded video content, streaming video content, still images, e.g., photographs including panoramic photographs, computer generated content, video games, user generated content, and so on.

The media content may be identified as providing an extended view format. For example, such an indication may be provided in one or more of a program listing and/or a media catalog. Alternatively or in addition, the availability of an expanded version of the media content may be presented to one or more viewers responsive to a selection of a media content item. Consider a user selects a program from a video on demand catalog. Upon selection, the viewer may be presented with a notification that the program is available in formats permitting expanded viewing by two, or perhaps more than to, e.g., up to some maximum number of shareable video screens.

The multi-screen viewing process 260 further includes evaluating whether a viewing session corresponds to a multi-screen viewing session at 262. For example, a primary viewer may select a media program from the on demand catalog, receive a notification that a multi-screen expanded viewing feature is available for the selected content. The primary viewer may then choose to view the content according to a solitary mode using a single display device, e.g., foregoing any expanded viewing experience. Alternatively, the primary viewer may select to proceed with a multi-screen expanded viewing experience.

To the extent the evaluation of the viewing session at 262 does not correspond to a multi-screen viewing session, a single-screen portion of multi-screen media content is presented for display at 263 via single display device. A single-screen session may result from the primary user providing a direct input, e.g., choosing a single-screen mode, or indirectly by not choose to initiate according to a multi-screen viewing format.

However, to the extent the evaluation of the viewing session at 262 does correspond to a multi-screen viewing session, a group of display devices may be identified at 264. Identification of the participating group of display devices may include a primary viewer's display device and one or more other display devices identified by a user interface of the primary viewer's display device. Alternatively or in addition, identification of the participating group of display devices may include the primary viewer's display device and one or more display devices identified within a range threshold from the primary user's display device. Still other options for identifying other participating devices may be based on acceptance of invitations sent to other devices, such as those nearby, and/or those devices associated with viewers within a social circle of the primary viewer, e.g., as identified by a user's contacts, a user's social media friend or circle, members of an affinity group, members of a family and/or other social group, and so on.

The process 260 may determine at 265, whether devices of the group of display devices are proximate with respect to any other devices of the group. Proximity may be determined according to one or more user inputs, e.g., indicating that the devices are proximate and/or that the devise are arranged in a particular proximate arrangement. Alternatively or in addition, proximity may be determined by sensors of one or more of the identified devices. Sensors may include proximity sensors, e.g., including any of the example sensors or other sensors generally known. In at least some embodiments, proximity may be determined according to one or more user inputs, such as the example user selections and/or gestures disclosed herein.

To the extent it is determined at 265 that the devices are not proximate, the process 260 may continue to monitor and/or evaluate proximity at 265. In at least some embodiments, an instruction, e.g., in the form of a message, may be provided to one or more devices of the group of display devices at 266 (shown in phantom). The instruction may provide a notification that another device is nearby. Such notifications may be filtered, e.g., according to one or more of a user's contact list, social group membership, past participations, affinity, and the like.

To the extent it is determined at 265 that the devices are proximate, the group of proximate devices are associated at 267. In at least some embodiments, the devices are associated to a mosaic pattern. The mosaic pattern may correspond to orientations and/or locations of the proximate devices. The mosaic pattern may be determined according to a user selection of a mosaic pattern proposed by a multi-screen expanded viewing application, e.g., hosted on the mobile device(s) and/or on a remote server, e.g., the content delivery server 202 (FIG. 2A).

Multi-screen media content may be distributed at 268 to the group of proximate display devices according to the configuration parameters. In general, the multi-screen media content may be delivered via any suitable manner including one or more of the various example media distribution techniques disclosed herein. For example, all segments of a multi-screen video frame may be sent to one mobile display device, e.g., a primary display device 206 (FIG. 2A) and distributed therefrom to one or more of the other participating companion mobile display devices 222a, 222b, 222c (FIG. 2A). Alternatively or in addition, different portions of the same video frame may be distributed to respective mobile display devices from a central source, such as the content delivery server 202.

Multi-screen media portion(s) may be presented at 269 for synchronized display via the group of proximate display devices. Each of the participating devices having received its respective frame portion, displays its portion upon its respective display screen. Given that the group of screens are arranged according to a preestablished mosaic pattern, the screens of the group of mobile display devices collectively present an expanded portion of the video frame in a coherent and logical manner, e.g., as though viewed by a single screen having an approximate size and/or shape of the corresponding mosaic pattern.

FIG. 2H depicts an illustrative embodiment of another multi-screen viewing process 270 in accordance with various aspects described herein. In at least some embodiments, the process initiates from a configuration in which multi-screen media portion(s) are being presented for synchronized display via a group of proximate display devices, e.g., as disclosed in step 269 (FIG. 2G). A determination is made at 271 as to whether group proximity is maintained. Proximity, once established, may be monitored periodically, e.g., every portion of a second, every few seconds, and/or every frame and/or repeatedly, e.g., after some predetermined number of frames have been presented, e.g., every 10^{th} frame, every 100^{th} frame, and the like.

To the extent it is determined at 271 that group proximity is being maintained, the process 270 may continue presentation of the multi-screen media portion(s) at 272 for synchronized display via the same group of proximate display devices. The process 270 may continue to monitor group proximity, e.g., determining again at 271 as to whether group proximity is maintained. However, to the extent it is determined at 271 that group proximity is no longer being maintained, one or more non-proximate group member(s) may be identified at 273. Identification of the non-proximate or departing display device may be determined according to user input and/or according to proximity sensors of the remaining devices and/or the departing display device.

Responsive to a determination that a display device has been removed from the participating group, a presentation of the multi-screen media portion(s) to the identified non-proximate group member(s) may be terminated at 271. Such termination may occur immediately, or after some predetermined delay period, e.g., to accommodate momentary displacement of one or more of the devices. In at least some embodiments a message may be displayed at one or more of the departing device and/or the remaining devices to query whether removal of the non-proximate device is intentional.

In at least some embodiments, the multi-screen media content to may be redistributed to the group of remaining proximate display device(s). For example, an initial mosaic pattern with all participating devices may be adjusted to a subsequent mosaic pattern with the remaining participating devices, e.g., without the departing device. To the extent a re-formatting of the FoVs projection onto the expanded view video frame, such a reformatting is performed, such that one or more of the remaining participating devices receives a respective adjusted portion of the video frame corresponding to the adjusted mosaic pattern. A modified version of the multi-screen media portion(s) may be presented at 276 for synchronized display via group of remaining proximate display devices.

FIG. 2I depicts an illustrative embodiment of another multi-screen viewing process 280 in accordance with various aspects described herein. In at least some embodiments, the process 280 initiates from a configuration in which multi-screen media portion(s) are being presented for synchronized display via a group of proximate display devices, e.g., as disclosed in step 269 (FIG. 2G). Input may be received at 281 from a display device of the group of proximate display devices during synchronized display.

A determination may be made at 282 as to whether the input requires adjustment to synchronized display. Input may be obtained from a user interface, e.g., a touchscreen interface of one of the participating mobile display devices, and/or input from another device, such as a keyboard, a touch pad, a joystick, etc. Adjustments may include, without limitation, a pan, a zoom and/or a rotation of a viewer's frame of reference. For example, a viewer may touch a touchscreen interface one of the display screens and provide a gesture input by dragging a finger in a direction that the user wishes to move the viewer's frame of reference. Other inputs may include a pinch to expand or reduce the viewer's frame of reference, and so on. In some embodiments, a multi-screen, or mosaic, extended-view presentation may be controlled from only one device, e.g., a primary display device. Thus, a viewer may initiate a control, such as a pan and/or a zoom from a touchscreen of the primary display device. Any controls entered by other participating display devices are ignored. Alternatively or in addition, control may be initiated by only one display device at a time. For example, a user at any one device may enter a control to adjust the presentation, the control being enacted upon by the system. However, any other controls attempted during a period of the first control are ignored. For example, a first user to attempt a control input blocks out other users control inputs for at east some period of time, e.g., a few seconds or more. In at least some embodiments, a user may control the video from any of the end-point devices, e.g., according to a democratic control.

To the extent it is determined at 282 that no adjustment to the synchronized display is required, the process 280 may continue with a presentation of the multi-screen video portion(s) for synchronized display via the group of proximate display devices. The process 280 may continue to monitor for subsequent input. However, to the extent it is determined at 282 that adjustment to the synchronized display is required, the process 280 may continue to obtain at 284 adjusted multi-screen video content according to the input.

The adjusted multi-screen video content, e.g., panned, scaled and/or rotated, may be distributed to the group of proximate display devices at 285, e.g., being applied to present and subsequent video frames until such further user input related to an adjustment of the viewer's frame of reference may be received. The adjusted multi-screen video portion(s) may be presented at 286 for presentation of the synchronized display via the group of proximate display devices.

FIG. 2J depicts an illustrative embodiment of yet another multi-screen viewing process 290 in accordance with various aspects described herein. The example process 290 may be implemented on one or more devices, such as the content delivery server 202 (FIG. 2A) and/or the mobile display devices 206, 222a, 222b, 222c.

A request for multi-screen media content is received from requesting device(s) at 291. The requesting devices may include one or more of the mobile display devices 206, 222a, 222b, 222. Alternatively or in addition, the requesting device may be another device, such as a user portal adapted to configure multi-screen, expanded viewing sessions. The user portal may be accessed from one or more of the mobile display devices 206, 222a, 222b, 222c, and/or via another configuration device, such as a separate configuration terminal.

A group of participating display devices is identified at 292. The group of participating display devices may be determined directly from a request, or subsequently, e.g., responsive to a request in which a configuration process is initiated. In at least some embodiments, the group of participating devices may include one or more of the requesting devices.

A particular multi-display configuration is determined at 293, e.g., according to group of display devices. In at least some embodiments, the particular multi-display configuration may include other configuration information as may be obtained in connection with the request at 292, and/or responsive to a configuration process initiated responsive to the request. In at least some embodiments, the particular multi-display configuration is determined responsive to sensor input obtained from one or more of the participating display devices. Alternatively or in addition, the particular multi-display configuration may be determined responsive to user input, e.g., as may be obtained from a gesture input along one or more touchscreen displays of the participating display devices.

One or more multi-screen media portion(s) are generated according to multi-display configuration at 194. Generation of the portions may be accomplished using any combination of the various example video frame portioning disclosed herein. For example, FoVs may be identified from configuration parameters of the participating display devices. Similarly, an overall orientation and/or arrangement of the multiple display devices, e.g., the mosaic pattern, may be used along or in combination the FoVs to identify corresponding spatial segments of the video frame.

The multi-screen media portion(s) may then be provided to the respective participating display devices at 295. For example, all of the portions may be provided to one or more of the requesting display device(s), and distributed to other participating display devices, as may be necessary, to accommodate a synchronized display via the group of display devices.

While for purposes of simplicity of explanation, the respective processes are shown and described as a series of blocks in FIGS. 2G, 2H, 2I and 2J, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

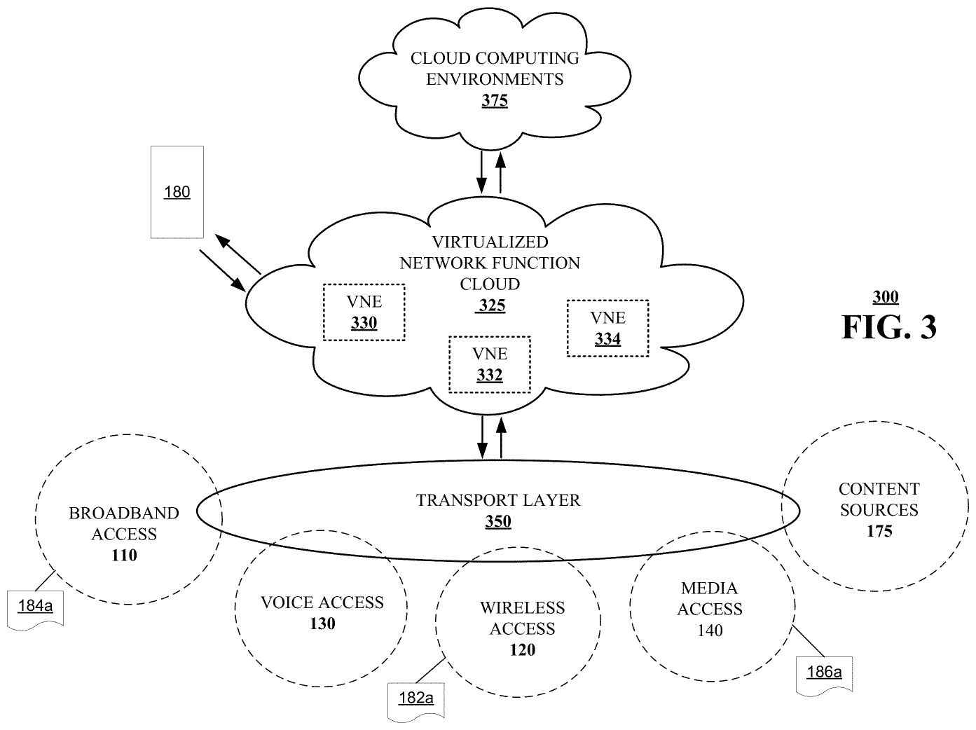

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of extendable viewing system 200, and processes 260, 270, 280, 290 presented in FIGS. 1, 2A through 2J and 3. For example, virtualized communication network 300 can facilitate in whole or in part identifying a media content item adapted for presentation via an extended viewport accessible through aggregation of a group of proximate mobile display devices. First and second mobile display devices may be associated together, e.g., when in close proximity to each other, and configuration parameters determined for the mobile display devices and/or their proximate group arrangement to facilitate identification of a corresponding viewport configuration. The first and second portions of the media content items are obtained by the first and second display devices to facilitate respective presentations of the first and second portions via the proximate group arrangement of the mobile displays. The first and second presentations provide a collective display of the extended portion of the media content item that would be otherwise inaccessible using a lesser number of mobile display devices.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

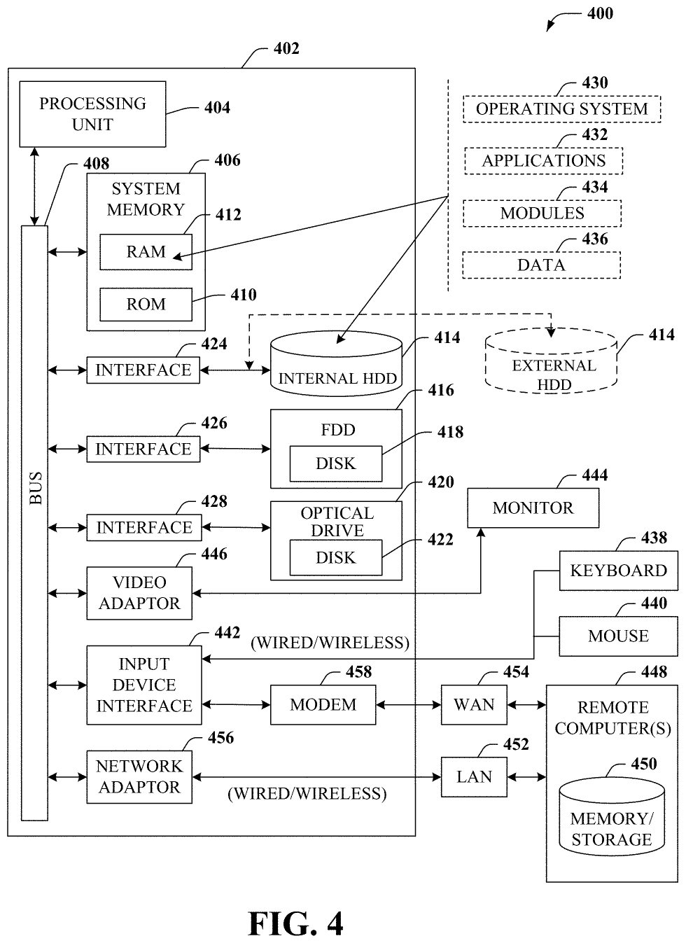

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part identifying a media content item adapted for presentation via an extended viewport accessible through aggregation of a group of proximate mobile display devices. First and second mobile display devices may be associated together, e.g., when in close proximity to each other, and configuration parameters determined for the mobile display devices and/or their proximate group arrangement to facilitate identification of a corresponding viewport configuration. The first and second portions of the media content items are obtained by the first and second display devices to facilitate respective presentations of the first and second portions via the proximate group arrangement of the mobile displays. The first and second presentations provide a collective display of the extended portion of the media content item that would be otherwise inaccessible using a lesser number of mobile display devices.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

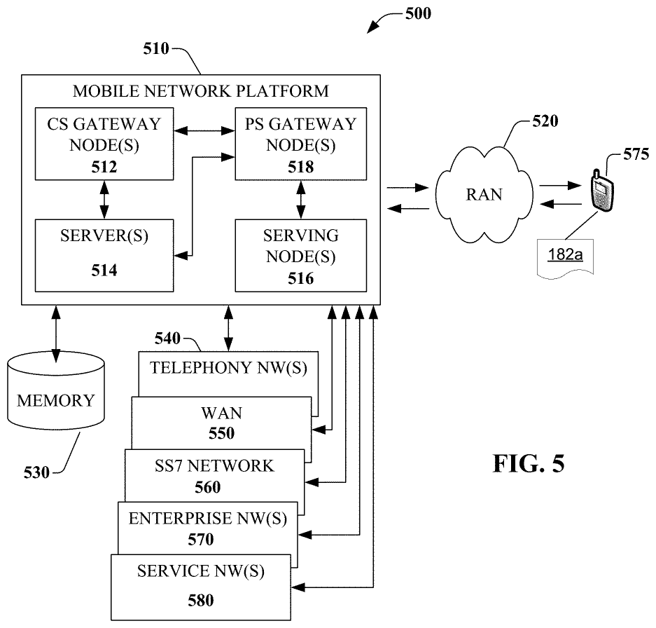

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part identifying a media content item adapted for presentation via an extended viewport accessible through aggregation of a group of proximate mobile display devices. First and second mobile display devices may be associated together, e.g., when in close proximity to each other, and configuration parameters determined for the mobile display devices and/or their proximate group arrangement to facilitate identification of a corresponding viewport configuration. The first and second portions of the media content items are obtained by the first and second display devices to facilitate respective presentations of the first and second portions via the proximate group arrangement of the mobile displays. The first and second presentations provide a collective display of the extended portion of the media content item that would be otherwise inaccessible using a lesser number of mobile display devices.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

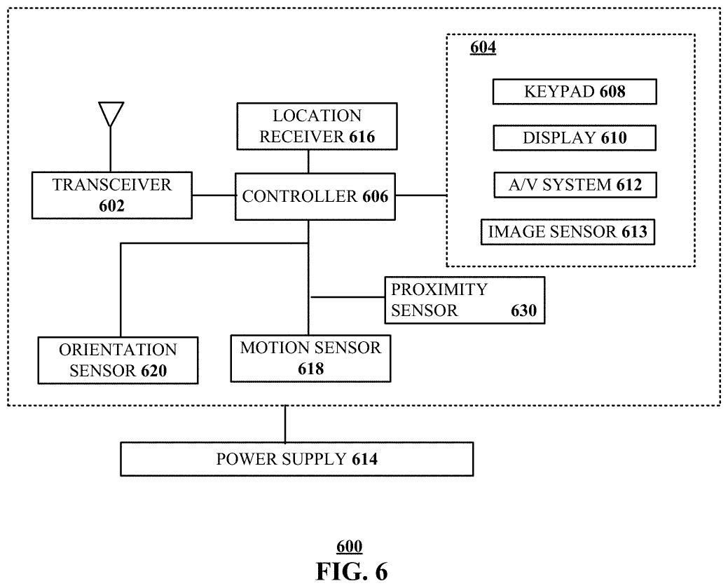

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part identifying a media content item adapted for presentation via an extended viewport accessible through aggregation of a group of proximate mobile display devices. First and second mobile display devices may be associated together, e.g., when in close proximity to each other, and configuration parameters determined for the mobile display devices and/or their proximate group arrangement to facilitate identification of a corresponding viewport configuration. The first and second portions of the media content items are obtained by the first and second display devices to facilitate respective presentations of the first and second portions via the proximate group arrangement of the mobile displays. The first and second presentations provide a collective display of the extended portion of the media content item that would be otherwise inaccessible using a lesser number of mobile display devices.

The communication device 600 can comprise a wireline and/or wireless transceiver 602 (herein transceiver 602), a user interface (UI) 604, a power supply 614, a location receiver 616, a motion sensor 618, an orientation sensor 620, a proximity sensor 630 and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

Although reference is made to video content according to the illustrative examples provided herein, it is understood that wide-view media content may include still images as well as video. The media content may be available in mono and/or stereo, e.g., 3D. It is further understood that the media content may include, without limitation, media recorded using a camera system, e.g., traditional photos and/or traditional video recordings of live events, computer generated content, e.g., computer generated images, special effects, animation, pre-recorded content and real-time or live content. The media may include content provided according to a channel lineup of a media service provider, on-demand content, e.g., from a video catalogue and/or streaming service provider, recorded content from a DVR, user generated content, and so on.

Whatever the particular type of content happens to be, the image frames may be configured, e.g., transformed and/or formatted into different spatial regions. At least one spatial region of the video frames may be associated with and/or otherwise allocated for presentation using a single mobile device. Consider a central region of an image or video presentation that may include a focal region of the extended or wide-view frames. In at least some embodiments, the formatting and/or transformations may anticipate different multi-display configurations. For example, a single mobile phone in landscape orientation, a group of two or three adjacent mobile phones having the same or different orientations, and so on. Alternatively or in addition, the formatting may be configured in a more general manner, e.g., identifying a single display view as a sub-area or region of the video frame, with extended areas or regions of the frame reserved for multi-display presentations.

Such reservations may be used to encourage participation between users to get together in a social context to permit a pooling of their mobile display devices, in a mosaic pattern to access the extended content. Extended content may include, without limitation a wider FoV of the wide-view content than would otherwise be possible using a single device. Alternatively or in addition, the extended content may include supplemental content, e.g., alternative views, alternative zoom, graphical and/or textual content. In at least some embodiments, the extended content viewable when using more than one device may include advertisements and/or messages that may only be viewable and/or unlocked when cooperatively using more than one proximate mobile display in the manners disclosed herein.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. By way of example, the media content may include image content and/or video content. The media content may include, without limitation, pre-recorded media content, such as movies, series episodes, pre-recorded sporting events, news broadcasts and so forth, pre-programmed content, e.g., according to a channel lineup, and/or live content that may be sourced externally or locally from one of the participating mobile display devices. Alternatively or in addition, the media content may include game content, such as video games, multi-player games, and so on. In at least some embodiments, the media content may include one or more of virtual reality, augmented reality, extended reality displays. Other examples of media content may include, without limitation, online virtual environments, such as a metaverse including persistent online 3-D virtual environments, and other software or applications for creating, manipulating and participating in 3D virtual environments e.g., Second Life® software. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A method, comprising:
identifying, by a processing system including a processor, a video content item comprising a first spatial segment adapted for a first presentation according to a primary viewport and a second spatial segment adapted for a second presentation according to an adjacent viewport, the primary and adjacent viewports facilitating access to an extended segment of the video content item otherwise inaccessible via the primary viewport alone;
associating, by the processing system, a primary mobile display device with an adjacent mobile display device to obtain a display device association;
identifying, by the processing system, configuration parameters of the primary and adjacent mobile display devices;
identifying, by the processing system, a mosaic configuration of the primary and adjacent viewports according to the configuration parameters;
receiving, by the processing system, the first and second spatial segments of the video content item;
providing, by the processing system, the first spatial segment for the first presentation via a first display of the primary mobile display device; and
providing, by the processing system, the second spatial segment to the adjacent mobile display device to facilitate the second presentation of the second spatial segment via a second display of the adjacent mobile display device, wherein the first and second presentations according to the mosaic configuration provide a collective display of the extended segment of the video content item, wherein a presentation of at least a portion of the video content item is prohibited in a single display setting.

2. The method of claim 1, further comprising:
determining, by the processing system, a proximity of adjacent mobile display device to the primary mobile display device, wherein the associating of the primary mobile display device with the adjacent mobile display device is responsive to the proximity.

3. The method of claim 2, further comprising:
comparing, by the processing system, the proximity to a proximity threshold to obtain a comparison, wherein the associating of the primary mobile display device with the adjacent mobile display device is responsive to the comparison.

4. The method of claim 1, further comprising:
evaluating, by the processing system, proximity of the adjacent mobile display device to the primary mobile display device during the collective display of the extended segment of the video content item;
determining, by the processing system, a change to the proximity of the adjacent mobile display device to the primary mobile display device to obtain a changed proximity; and
terminating, by the processing system, the providing the second spatial segment to the adjacent mobile display device.

5. The method of claim 4, further comprising:
adjusting, by the processing system, the mosaic configuration to remove the adjacent viewport according to the terminating the providing the second spatial segment to obtain an adjusted mosaic configuration; and
adjusting, by the processing system, the collective display of the extended segment of the video content item according to the adjusted mosaic configuration.

6. The method of claim 1, further comprising:
receiving, by the processing system, an input from one of the primary and adjacent mobile display devices; and
adjusting, by the processing system, the configuration parameters corresponding to the input to obtain adjusted configuration parameters.

7. The method of claim 6, wherein the input comprises one of a gesture to pan, a gesture to zoom or a combination thereof.

8. The method of claim 1, wherein the configuration parameters comprise a first field of view (FoV) and a line of sight (LoS) of the primary mobile display device, and a second FoV of the primary and adjacent mobile display devices, the primary viewport determined according to the first FoV and the LoS, and the adjacent viewport determined according to the second FoV and mosaic configuration.

9. The method of claim 8, further comprising:
determining, by the processing system, a first orientation of the primary mobile display device and a second orientation of the primary and adjacent mobile display devices, wherein the configuration parameters further comprise the first and second orientations.

10. The method of claim 1, wherein the video content item comprises a panoramic video content item.

11. (canceled)

12. A device, comprising:
a processing system including a processor; and
a memory that stores executable instructions that, when executed by the processing system, facilitate performance of operations, the operations comprising:
identifying a media content item comprising a first spatial segment adapted for a first presentation according to a primary viewport and a second spatial segment adapted for a second presentation according to an adjacent viewport, the primary and adjacent viewports facilitating access to an extended segment of the media content item otherwise inaccessible via the primary viewport;
associating a first display device with a second display device;
identifying configuration parameters of the first and second display devices;
identifying a mosaic configuration of the primary and adjacent viewports according to the configuration parameters;
receiving the media content item comprising the first and second spatial segments;
providing the first spatial segment for the first presentation via a first display of the first display device; and
providing the second spatial segment to the second display device to facilitate the second presentation of the second spatial segment via a second display of the second display device, wherein the first and second presentations according to the mosaic configuration provide a collective display of the extended segment of the media content item, wherein a presentation of at least a portion of the media content item is prohibited in a single display setting.

13. The device of claim 12, wherein the receiving the first and second spatial segments of the media content item further comprises receiving both the first and second spatial segments via only the first display device.

14. The device of claim 13, wherein the providing the second spatial segment to the second display device further comprises:
establishing a peer-to-peer network extending between the first and second display devices, wherein the providing the second spatial segment comprises utilizing the peer-to-peer network.

15. The device of claim 12, wherein the operations further comprise:
sending, by the first display device, a message to the second display device responsive to the identifying the media content item, the message comprising an invitation to participate in a shared, mosaic viewing of the media content item.

16. The device of claim 15, wherein the operations further comprise:
monitoring proximity data corresponding to proximity of the first and second display devices; and
associating the first and second display devices responsive to the proximity data indicating adjacency of the first and second display devices.

17. The device of claim 16, wherein the monitoring proximity data further comprises utilizing a near-field sensor of the first display device.

18. A non-transitory, machine-readable medium, comprising executable instructions that, when executed by a processing system including a processor, facilitate performance of operations, the operations comprising:
identifying a media content item comprising a first portion adapted for a first presentation according to a first viewport and a second portion adapted for a second presentation according to a second viewport, the first and second viewports facilitating access to an extended portion of the media content item otherwise inaccessible via the first viewport;
associating a first display device with a second display device;
determining configuration parameters of the first and second display devices;
identifying a viewport configuration of the first and second viewports according to the configuration parameters;
receiving the media content item comprising the first and second portions;
providing the first portion for the first presentation via the first display device; and
providing the second portion to the second display device to facilitate the second presentation of the second portion via the second display device, wherein the first and second presentations according to the viewport configuration provide a collective display of the extended portion of the media content item, wherein a presentation of at least a portion of the media content item is prohibited in a single display setting.

19. The non-transitory, machine-readable medium of claim 18, wherein the operations further comprise:
synchronizing the first and second presentations to provide a synchronized collective display of the extended portion of the media content item.

20. The non-transitory, machine-readable medium of claim 18, wherein the media content item comprises a still image.

21. The method of claim 1, wherein the at least a portion of the video content item comprises the second spatial segment.
